(19) United States
(12) Patent Application Publication
(10) Pub. No.: US 2023/0245359 A1
(43) Pub. Date: Aug. 3, 2023

(54) INFORMATION PROCESSING APPARATUS, INFORMATION PROCESSING METHOD, AND COMPUTER-READABLE RECORDING MEDIUM

(71) Applicant: SONY GROUP CORPORATION, Tokyo (JP)

(72) Inventor: Shunichi KASAHARA, Kanagawa (JP)

(73) Assignee: SONY GROUP CORPORATION, Tokyo (JP)

(21) Appl. No.: 17/914,191

(22) PCT Filed: Mar. 17, 2021
(86) PCT No.: PCT/JP2021/010807

§ 371 Date: Jan. 18, 2023

(30) Foreign Application Priority Data
Mar. 31, 2020 (JP) 2020-064998

(51) Int. Cl. G06T 11/60; G06F 3/04883; G06F 3/04845; G06V 30/22

(52) U.S. Cl. CPC G06T 11/60; G06F 3/04883; G06F 3/04845; G06V 30/22; G06T 2210/44; G06T 2200/24

(57) ABSTRACT

An information processing apparatus according to an embodiment of the present technology includes a display control unit. The display control unit controls a display apparatus to display a target object that is a correction target and controls the display apparatus to change, in accordance with a display state of the target object after the target object is displayed, the target object into an intermediate object between the target object and a reference object corresponding to the target object.

### TECHNICAL FIELD

The present technology relates to an information processing apparatus, an information processing method, and a computer-readable recording medium that corrects display.

### BACKGROUND ART

Conventionally, a technology of correcting a display object displayed on a display or the like has been developed. For example, Patent Literature 1 has described a method of correcting a display object displayed to a communication partner when remote communication is performed. In this method, for example, a captured image obtained by imaging a space in which the user is located is displayed to the partner as the display object. At this time, in a case where the partner is not carefully watching the display object, an appearance of the display object is corrected. Accordingly, it is possible to decorate the space in which the user is located or the user him or herself without being noticed by the partner (paragraphs [0025], [0054], and [0058] of specification, and FIG. 6, and the like in Patent Literature 1).

### CITATION LIST

### Patent Literature

Patent Literature 1: WO 2019/176236

### DISCLOSURE OF INVENTION

### Technical Problem

As described above, in a case where, for example, the user observes the moment when the display object is corrected as it is, there is a possibility that the fact itself that the correction is made outstands. Therefore, it is desirable to provide a technology of correcting display without being noticed by the user.

In view of the above-mentioned circumstances, it is an object of the present technology to provide an information processing apparatus, an information processing method, and a computer-readable recording medium that can correct display without being noticed by the user.

### Solution to Problem

In order to accomplish the above-mentioned object, an information processing apparatus according to an embodiment of the present technology includes a display control unit.

The display control unit controls a display apparatus to display a target object that is a correction target and controls the display apparatus to change, in accordance with a display state of the target object after the target object is displayed, the target object into an intermediate object between the target object and a reference object corresponding to the target object.

In this information processing apparatus, the display apparatus outputs the target object that is the correction target. Then, in accordance with the display state of the target object after output, the display apparatus is controlled so that the target object changes into the intermediate object between the target object and the reference object corresponding to the target object. By changing the target object in accordance with the display state of the target object in this manner, it becomes possible to correct the display without being noticed by the user.

The display control unit may detect the display state that causes visual change blindness to a user who watches the target object and control the display apparatus to change, in accordance with a timing at which the display state that causes the visual change blindness is detected, the target object into the intermediate object.

The display control unit may control the display apparatus so that the intermediate object becomes closer to the reference object every time the display state that causes the visual change blindness is detected.

The display control unit may detect, as the display state, a state in which a display parameter including at least one of a position, a size, or an attitude of the target object is changed in accordance with an input operation by a user, and control the display apparatus to change the target object into the intermediate object on the basis of the detection result.

The input operation by the user may include at least one of a movement operation, a size change operation, or a rotation operation by the user with respect to the target object.

The display control unit may control the display apparatus to change the target object into the intermediate object in accordance with a timing at which at least one of an amount of change of the display parameter, a time for which the display parameter is changed, or a change speed of the display parameter exceeds a predetermined threshold.

The display control unit may detect, as the display state, a state in which display of the target object is hindered, and controls the display apparatus to change the target object into the intermediate object on the basis of the detection result.

The display control unit may generate a screen image that is output of the display apparatus, and detects a state in which the target object is occluded in the screen image or a state in which the target object is blurred in the screen image.

The display apparatus may have a display surface. In this case, the display control unit may detect a state in which display of the target object is hindered on the display surface.

The display control unit may detect a hindered region in which the display of the target object is hindered, and control the display apparatus to change the target object included in the hindered region into the intermediate object.

The display control unit may control the display apparatus to discontinuously change the target object into the intermediate object.

The display control unit may generate the intermediate object so that a development process of the change from the target object to the intermediate object is not identifiable.

The display control unit may generate the intermediate object by performing a morphing process of making the target object closer to the reference object.

The target object may be a handwritten object representing an input result of handwriting input by the user. In this case, the reference object may be an estimated object obtained by estimating input contents of the handwriting input.

The display control unit may generate the intermediate object by performing a morphing process of making the handwritten object closer to the estimated object, and set a rate of the morphing process that is applied to the handwritten object to be smaller than a rate of the morphing process in a case where a result of the morphing process coincides with the estimated object.

The handwritten object may be at least one of an object representing a handwritten character by the user or an object representing a handwritten icon by the user.

The target object may be a first image object. In this case, the reference object may be a second image object different from the first image object.

An information processing method according to an embodiment of the present technology is an information processing method performed by a computer system and includes controlling a display apparatus to display a target object that is a correction target and controlling the display apparatus to change, in accordance with a display state of the target object after the target object is displayed, the target object into an intermediate object between the target object and a reference object corresponding to the target object.

A computer-readable recording medium according to an embodiment of the present technology records a program that causes a computer system to execute the following step.

A step of controlling a display apparatus to display a target object that is a correction target and controlling the display apparatus to change, in accordance with a display state of the target object after the target object is displayed, the target object into an intermediate object between the target object and a reference object corresponding to the target object.

### BRIEF DESCRIPTION OF DRAWINGS

FIG. 1 A schematic view showing an appearance of a terminal apparatus according to an embodiment of the present technology.

FIG. 2 A block diagram showing a configuration example of the terminal apparatus.

FIG. 3 A diagram showing an example of visual change blindness.

FIG. 4 A flowchart showing an example of an operation of the terminal apparatus.

FIG. 5 A schematic view showing an example of a morphing process.

FIG. 6 A schematic view for describing a method of displaying a correction result.

FIG. 7 A schematic view showing an example of character correction associated with a movement operation.

FIG. 8 A schematic view showing an example of character correction associated with a magnification operation.

FIG. 9 A schematic view showing an example of character correction associated with a rotation operation.

FIG. 10 A schematic view showing an example of correction associated with occlusion of a target object in a screen image.

FIG. 11 A schematic view showing an example of correction associated with occlusion of a target object on a display surface of a display.

FIG. 12 A schematic view showing an example of a morphing process regarding an illustration of handwriting.

FIG. 13 A schematic view showing an example of correction regarding the handwritten illustration.

FIG. 14 A schematic view showing an example of correction regarding an image object.

### MODE(S) FOR CARRYING OUT THE INVENTION

Hereinafter, embodiments according to the present technology will be described with reference to the drawings.

[Configuration of Terminal Apparatus]

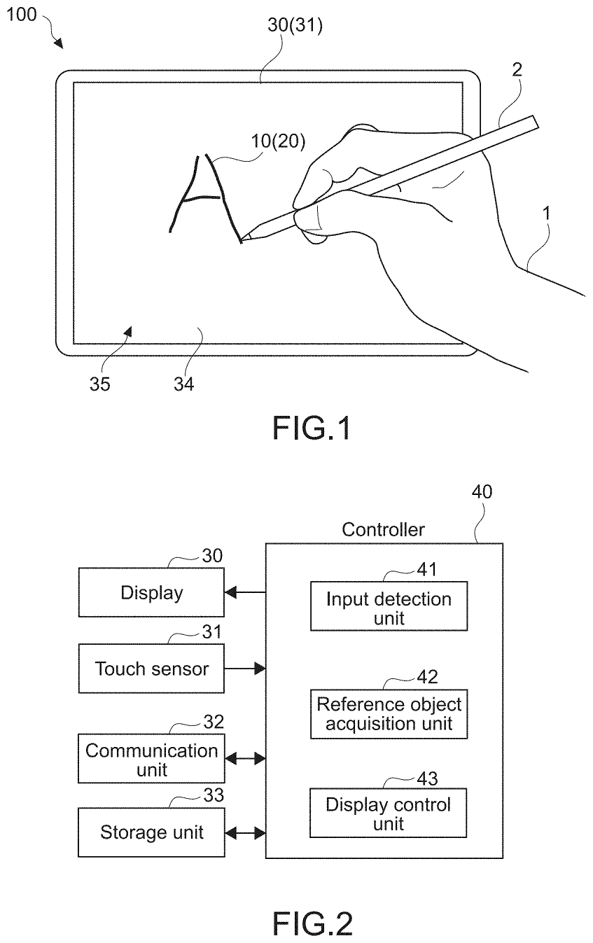

FIG. 1 is a schematic view showing an appearance of a terminal apparatus according to the embodiment of the present technology. A terminal apparatus 100 is an apparatus provided with a display 30 (touch display) capable of touch operation. As the terminal apparatus 100, for example, a tablet terminal, a smartphone terminal, or the like is used.

A variety of display objects are output to the display 30 of the terminal apparatus 100. Here, the display object is an object displayed on the display 30. The display object includes any object such as a character, an illustration, a photograph, and a drawing.

A user 1 who uses the terminal apparatus 100 is able to, for example, view a display object displayed on the display 30 and intuitively perform an input operation such as moving and zooming the display object or editing the display object by touching the display 30.

Moreover, the user 1 is able to input a character, an icon, or the like by handwriting through the display 30. In this case, a display object representing an input result of the handwriting input by the user 1 is displayed on the display 30. Thus, in the terminal apparatus 100, the drawing can be directly performed on the display 30.

FIG. 1 schematically depicts a state in which the user 1 inputs a character (here, a capital letter “A” of alphabets) on the display 30 of the terminal apparatus 100 with a touch pen 2.

For example, when the user 1 operates the touch pen 2 to draw the character on the display 30, a trace of a tip of the touch pen 2 touching the display 30 is detected by a touch sensor 31. Then, an object representing the trace of the tip of the touch pen 2 is displayed on the display 30 as a display object.

In the terminal apparatus 100, a display object of those display objects displayed on the display 30, which is a correction target, is corrected in accordance with its display state. Hereinafter, the display object that is the correction target will be referred to as a target object 10.

For example, an object (handwritten object 20) representing the trace of the tip of the touch pen 2 shown in FIG. 1 is an example of the target object 10 that is the correction target.

Moreover, in the present embodiment, the target object 10 is corrected gradually multiple times, for example. Therefore, the target object 10 corrected once (intermediate object to be described later) can be a correction target again. That is, irrespective of whether or not it is an object corrected already, the display object that is the correction target can be the target object 10.

A method of correcting the target object 10 will be described later in detail.

FIG. 2 is a block diagram showing a configuration example of the terminal apparatus 100. As shown in FIG. 2, the terminal apparatus 100 includes a communication unit 32, a storage unit 33, and a controller 40 in addition to the display 30 and the touch sensor 31 described above.

The display 30 has a display surface 34 and is disposed in the terminal apparatus 100 with the display surface 34 facing outwards. The display surface 34 is a surface on which the display objects are displayed.

Data about a the screen image 35 generated by the controller 40 to be described later is input to the display 30. Here, the screen image 35 is an image that configures a screen displayed on the entire display surface 34. This screen image 35 includes the variety of display objects.

As the display 30, for example, a liquid crystal display (LCD) with a liquid-crystal display element, an organic EL display, or the like is used. In addition, a specific configuration of the display 30 is not limited. In the present embodiment, the display 30 corresponds to a display apparatus.

The touch sensor 31 is a sensor that detects contact of a finger of the user 1, the touch pen 2, or the like with the display surface 34. The touch sensor 31 detects contact/non-contact of the finger of the user 1 and a contact position on the display surface 34. As the touch sensor 31, for example, a contact detection sensor of a capacitance type or the like provided on the display surface 34 (display 30) is used. Further, a camera or the like that images the finger of the user 1 or the touch pen 2 with respect to the display surface 34 may be used as the touch sensor 31. In addition, a specific configuration of the touch sensor 31 is not limited.

The communication unit 32 is a module for performing network communication, short-range wireless communication, or the like with other devices. As the communication unit 32, for example, a wireless LAN module such as Wi-Fi or a communication module such as Bluetooth (registered trademark) is provided. In addition, a communication module or the like capable of communication based on wired connection may be provided.

The storage unit 33 is a nonvolatile storage device. For example, a recording medium using a solid-state element such as a solid state drive (SSD) or a magnetic recording medium such as a hard disk drive (HDD) is used as the storage unit 33. In addition, the kinds of recording media that are used as the storage unit 33 and the like are not limited, and for example, any recording medium that records data non-transitorily may be used.

A control program according to the present embodiment is stored in the storage unit 33. The control program is, for example, a program for controlling the overall operation of the terminal apparatus 100. Moreover, data about the reference object to be described later is stored in the storage unit 33. In addition, information stored in the storage unit 33 is not limited.

In the present embodiment, the storage unit 33 corresponds to a computer-readable recording medium on which a program is recorded. Moreover, the control program corresponds to the program recorded on the recording medium.

The controller 40 controls the operation of the terminal apparatus 100. The controller 40, for example, has a hardware configuration required for computer, such as a CPU and a memory (RAM, ROM). The CPU loads the control program stored in the storage unit 33 into the RAM and executes the control program, and various types of processing are thus performed. The controller 40 corresponds to an information processing apparatus according to the present embodiment.

For example, a programmable logic device (PLD) such as a field programmable gate array (FPGA) or another device such as an application specific integrated circuit (ASIC) may be used as the controller 40. Moreover, for example, a processor such as a graphics processing unit (GPU) may be used as the controller 40.

In the present embodiment, the CPU of the controller 40 executes the program (control program) according to the present embodiment, and an input detection unit 41, a reference object acquisition unit 42, and a display control unit 43 are thus realized as functional blocks. Then, these functional blocks perform the information processing method according to the present embodiment. It should be noted that dedicated hardware such as integrated circuit (IC) may be used as appropriate in order to realize the respective functional blocks.

The input detection unit 41 detects a handwriting input by the user 1. Specifically, the input detection unit 41 generates input data representing input contents of the handwriting input on the basis of a detection result of contact with the display surface 34 (display 30), which is detected by the touch sensor 31.

For example, it is assumed that as shown in FIG. 1, the user 1 draws “A” by handwriting. In this case, on the basis of the detection result of the touch sensor 31, stroke data representing the handwriting made by the user 1 is detected as input data. Here, the stroke data is, for example, vector data representing a single continuous stroke of handwriting. For example, the stroke data “A” shown in FIG. 1 is data including three strokes consisting of two lines close to each other on the upper side in the figure and a line connecting these lines.

Moreover, the input detection unit 41 estimates contents of the handwriting input by the user 1 on the basis of the input data. Specifically, a predetermined recognition process is performed on the input data (stroke data) of the handwriting input, and the contents of the handwriting input by the user 1 are estimated. For example, on the basis of the input data of the handwriting input shown in FIG. 1, the contents drawn by the user 1 are estimated to be the capital letter, alphabet “A”.

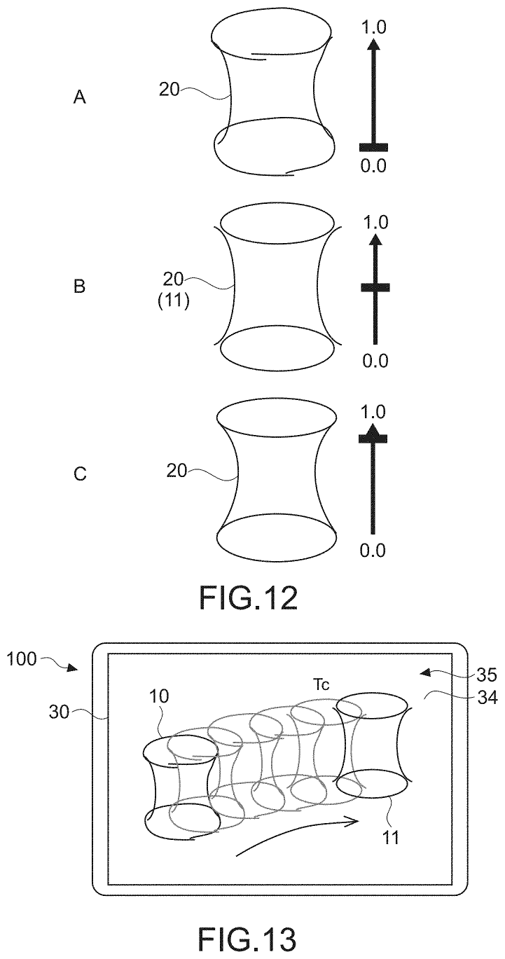

Further, contents of an icon such as an illustration that the user 1 has input by handwriting can also be estimated (see FIG. 12 and the like). For example, kind and shape, e.g., whether a line input by the user 1 is a straight line or curve line are estimated. Moreover, for example, in a case where the user 1 draws a circular icon, the kind of circle, e.g., whether the icon is ellipse or perfect circle is estimated.

A method of estimating the contents of the handwriting input is not limited, and for example, a method of performing character recognition or figure recognition using pattern matching, machine learning, or the like may be used as appropriate.

The reference object acquisition unit 42 acquires data about a reference object. Here, the reference object is an object that is referred to when correcting the target object 10 displayed on the display 30, and is an object that is criteria for correcting the target object 10.

For example, when the target object 10 that is the correction target is determined, the data about the reference object corresponding to the target object 10 is read from the storage unit 33. Alternatively, the reference object corresponding to the target object 10 is newly generated. In addition, a method of acquiring the data about the reference object is not limited.

The display control unit 43 controls the display of the display 30 (output of the display 30). Specifically, the display control unit 43 generates the screen image 35 that is the output of the display 30. By generating this screen image 35 as appropriate, the contents displayed on the display 30 are controlled.

In the present embodiment, the display control unit 43 controls the display 30 to display the target object 10 that is the correction target. Specifically, the screen image 35 including the target object 10 is generated and is output to the display 30.

Furthermore, the display control unit 43 performs a correction process for the target object 10 in accordance with the display state of the target object 10 displayed on the display 30.

Here, the display state of the target object 10 is a state of display of the target object 10, i.e., how the target object 10 looks.

For example, the display state of the target object 10 (how it looks) is different between a state in which the target object 10 is displayed stationary and a state in which the target object 10 displayed moving. Moreover, for example, in a case where the target object 10 is hidden by another object or in a case where light is reflected on the display surface 34, it is a display state in which the display of the target object 10 is hindered. In accordance with such a state regarding how the target object 10 looks, the target object 10 is corrected.

In the present embodiment, the target object 10 is corrected by changing the target object 10 into an intermediate object.

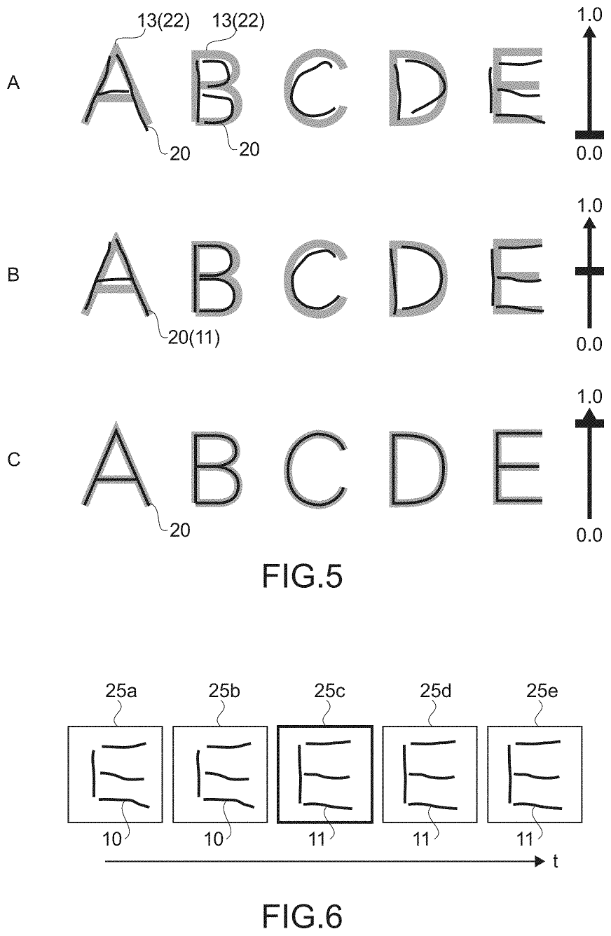

Here, the intermediate object is an object between the target object 10 and a reference object 13 that is criteria for correcting it. For example, in the object representing the handwritten character, an object obtained by making the respective strokes closer to the reference object (font object or the like) is the intermediate object (see FIG. 5).

Thus, in accordance with the display state of the target object 10 after the target object 10 is displayed, the display control unit 43 controls the display 30 to change the target object 10 into the intermediate object between the target object 10 and the reference object corresponding to the target object 10.

For example, in place of the target object 10 displayed up to that time, the screen image 35 in which the intermediate object is arranged is generated and is output to the display 30. As a result, in the display 30, the target object 10 switches to the intermediate object, and the target object 10 is corrected. This correction timing is determined in accordance with the display state of the target object 10.

In the present embodiment, the display control unit 43 detects a display state that causes visual change blindness to the user 1 who watches the target object 10. Then, in accordance with the timing at which the display state that causes the visual change blindness is detected, the display 30 is controlled to change the target object 10 into the intermediate object.

Here, the visual change blindness is a human characteristic that people fail to notice (or are hard to notice) changes of targets to be visually recognized under particular conditions. Therefore, it can be said that the display state that causes the visual change blindness to the user 1 is a state in which before and after the target object 10 is changed, it is difficult to notice the change.

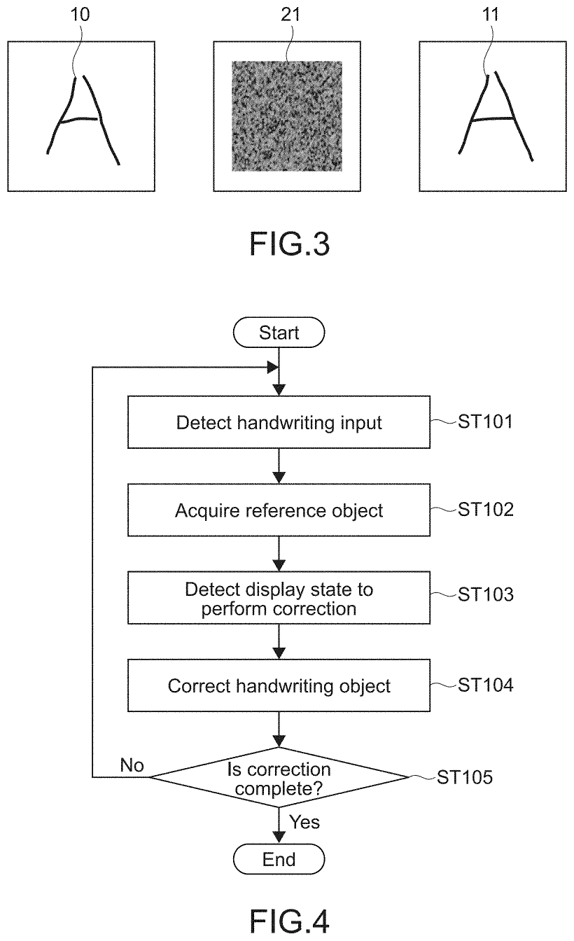

FIG. 3 is a diagram showing an example of the visual change blindness.

On the left-hand side of FIG. 3, the target object 10 that is the correction target (the handwritten object 20 obtained by handwriting the character “A”) is depicted. Moreover, on the right-hand side of FIG. 3, an intermediate object 11 obtained by correcting the target object 10 using the predetermined reference object as the criteria is depicted. Moreover, at the center of FIG. 3, an occlusion object 21 (here, mosaic pattern) that occludes the target object 10 is depicted.

For example, it is assumed that the display on the display 30 changes in the order of the left-hand side, the center, and the right-hand side in FIG. 3. That is, it is assumed that the target object 10 is switched to the occlusion object 21, and thereafter, the occlusion object 21 is switched to the intermediate object 11.

At this time, it is difficult for the user 1 who has watched the target object 10 to notice changes of the respective strokes of the character “A” before and after the occlusion object 21 is displayed. Thus, the visual change blindness in which it is difficult to notice the fact itself that the target object 10 is corrected to be the intermediate object 11 due to the occlusion of the target object 10 occurs to the user 1.

It should be noted that the occurrence of the visual change blindness is not limited to he case where the target is occluded. For example, as it will be described later, the visual change blindness can also occur in a case where the target is moved, for example.

In the terminal apparatus 100, the correction of the target object 10 is performed utilizing such visual change blindness. For example, in accordance with a timing at which the visual change blindness occurs, the target object 10 is switched to the intermediate object 11. Accordingly, it becomes possible to correct the target object 10 without being noticed by the user 1.

Hereinafter, the visual change blindness will be sometimes simply referred to as change blindness.

[Correction of Hand Writing Input]

Hereinafter, a method of correcting the handwriting input by the user 1 will be described. In this case, the target object 10 is the handwritten object 20 representing the input result of the handwriting input by the user 1. For example, the object representing the trace of the tip of the touch pen 2 shown in FIG. 1 is an example of the handwritten object 20.

Moreover, as it will be described later, the handwritten object 20 is, for example, corrected gradually multiple times. A series of objects modified by those correction processes are all included in the handwritten object 20 representing the input result of the handwriting input by the user 1.

In the present embodiment, the display control unit 43 generates the handwritten object 20 and outputs the handwritten object 20 to the display 30.

For example, in a case where the handwriting input by the user 1 is performed, the handwritten object 20 is generated on the basis of the input data representing the input contents of the handwriting input, which has been generated by the input detection unit 41. Then, the screen image 35 including the handwritten object 20 is generated and is output to the display 30. Accordingly, the handwritten object 20 before it is corrected is displayed on the display 30 as the target object 10.

Moreover, for example, in a case where the correction process for the handwritten object 20 is performed, the screen image 35 including the corrected handwritten object 20 (intermediate object 11) is generated and is output to the display 30. Accordingly, the corrected handwritten object 20 is displayed on the display 30.

It should be noted that in a case where the corrected handwritten object 20 (intermediate object 11) is further corrected, the corrected handwritten object 20 is a new target object 10.

FIG. 4 is a flowchart showing an operation example of the terminal apparatus 100. Here, a process of correcting the handwriting input by the user 1 will be described with reference to FIG. 4.

First of all, the input detection unit 41 detects a handwriting input by the user 1 (Step 101).

For example, when the user 1 performs the handwriting input on the display 30 (display surface 34), a trace of the contact position is detected by the touch sensor 31. On the basis of this detection result of the touch sensor 31, input data representing input contents of the handwriting input is generated. Then, on the basis of the input data, the input contents of the handwriting input are estimated.

For example, predetermined character recognition or figure recognition is performed on the input data, and kind and the like of the character or icon input by handwriting are estimated.

Moreover, at a timing at which the handwriting input by the user 1 is performed, the display control unit 43 generates a handwritten object 20 on the basis of the input data generated by the input detection unit 41. The generated handwritten object 20 is output to the display 30 as a part of the screen image 35.

The reference object acquisition unit 42 acquires a reference object corresponding to the handwritten object 20 (Step 102).

Specifically, an estimated object obtained by estimating the input contents of the handwriting input is acquired as the reference object. For example, on the basis of the estimation result for the handwriting input by the user 1 by the input detection unit 41, data about the estimated object stored in the storage unit 33 is read. Alternatively, the estimated object is generated on the basis of the estimation result for the handwriting input.

For example, in a case where the user 1 inputs a character by handwriting, the handwritten object 20 is an object representing the handwritten character by the user.

A font object representing each character is stored in the storage unit 33 as the estimated object for correcting the handwritten character. In a case where the contents of the handwriting input by the user 1 are a character, a font object (estimated object) corresponding to the estimation result of the character is read from the storage unit 33.

Moreover, for example, in a case where the user 1 inputs an icon by handwriting, the handwritten object 20 is an object representing the handwritten icon by the user.

In this case, an estimated object for correcting the handwritten icon is generated on the basis of the estimation result. Specifically, an icon object (estimated object) representing an estimation result obtained by estimating contents of the icon (kind and the like of line or figure) is generated.

Here, the icon object is, for example, stroke data including the stroke corresponding to the icon drawn by the user 1. For example, in a case where it is estimated that the user 1 draws an ellipse, an icon object including an elliptical stroke is generated.

The display control unit 43 detects a display state for correcting the handwritten object 20 (target object 10) currently displayed on the display 30 (Step 103).

Specifically, the display state that causes the visual change blindness to the user 1 is detected as the display state for performing the correction. In general, the display state of each object on the display 30 differs for each object (or for each region in which each object is displayed). Here, the display state in which the change blindness occurs is detected for each handwritten object 20 (target object 10) displayed on the display 30.

For example, regarding each handwritten object 20 currently displayed on the display 30, whether or not the display is in a state that causes the change blindness is determined. This determination process is continuingly performed until the display state that causes the change blindness is detected.

When the display state for performing the correction, i.e., the display state that causes the change blindness is detected, the display control unit 43 performs a correction process of correcting the handwritten object 20 that is the target (Step 104).

In the present embodiment, the intermediate object 11 is generated by performing a morphing process of making the handwritten object 20 (target object 10) closer to the estimated object (reference object). Then, in place of the handwritten object 20 displayed on the display up to that time, the intermediate object 11 is displayed. Accordingly, the handwritten object 20 is corrected.

It should be noted that the morphing process may be performed in advance in a phase before the display state that causes the change blindness is detected.

FIG. 5 is a schematic view showing an example of the morphing process. In FIG. 5A to FIG. 5 C, handwritten objects 20 representing the capital letters, alphabets “A”, “B”, “C”, and “D”, and “E” are schematically depicted with the black solid lines. Each of the lines respectively constituting the handwritten object 20s is stroke data (vector stroke).

Further, in FIG. 5A to FIG. 5 C, estimated objects 22 (reference objects 13) respectively corresponding to the handwritten objects 20 are schematically depicted as the gray regions. The estimated objects 22 are stroke data representing the respective characters (“A”, “B”, “C”, and “D”, and “E”) with a predetermined font.

At the right ends of FIG. 5A to FIG. 5 C, gauges each showing a rate of the morphing process are schematically depicted. The rate of the morphing process represents, for example, rate for making the handwritten object 20 closer to the estimated objects 22. Here, it is assumed that as the rate of the morphing process becomes closer to 1 from 0, the handwritten object 20 becomes closer to the estimated objects 22.

In FIG. 5A, the rate of the morphing process is set to be 0. Therefore, each handwritten object 20 shown in FIG. 5A is an object to which the correction based on the morphing process is not applied, and is an object representing the input result of the handwriting input by the user 1 with no change.

Moreover, in FIG. 5 B, the rate of the morphing process is set to be between 0 and 1 (e.g., 0.5 or the like). In this case, the respective handwritten objects 20 are the intermediate objects 11 corrected to become closer to the estimated objects 22 in accordance with the rate of the morphing process.

Moreover, in FIG. 5 C, the rate of the morphing process is set to be 1. Therefore, the respective handwritten objects 20 in FIG. 5 C are objects that coincide with the estimated objects 22.

In the present embodiment, the display control unit 43 sets the rate of the morphing process to be higher every time the display control unit 43 corrects the handwritten objects 20 (target objects 10). Therefore, the intermediate objects 11 generated at the time of correction gradually change into objects closer to the estimated objects 22. In the terminal apparatus 100, the intermediate objects 11 that become closer to the estimated objects 22 every time the correction is performed in this manner are output to the display 30.

Thus, every time the display control unit 43 detects the display state that causes the visual change blindness, the display control unit 43 controls the display 30 so that the intermediate objects 11 become closer to the estimated objects 22 (reference objects 13). Accordingly, correction that rapidly changes the handwritten objects 20 is avoided, and it becomes possible to avoid discomfort and the like due to the correction.

Further, in a case where the handwritten objects 20 are set as the correction targets (target objects 10), an upper limit value may be set for the rate of the morphing process. That is, final correction results of the handwritten objects 20 do not need to coincide with the estimated objects 22.

In this case, the display control unit 43 sets the rate of the morphing process to be applied to the handwritten objects 20 to be lower than the rate of the morphing process (here, 1) in a case where the results of the morphing process coincide with the estimated objects 22.

For example, when the rate of the morphing process becomes 1 finally, it may be clear that the handwritten objects 20 are corrected. In such a case, the rate of the morphing process is adjusted as appropriate to be a value lower than 1. Accordingly, it becomes possible to correct the input result of the handwriting input while keeping input habit, characteristics, and the like of an individual user. Accordingly, the user 1 can retain well corrected characters and the like as data while keeping the user's originality.

FIG. 6 is a schematic view for describing a method of displaying the correction result. Here, a method of switching the target object 10 that is the correction target (handwritten object 20) to the intermediate object 11 that is its correction result will be described.

In FIG. 6, a state in which the handwritten object 20 that is the target object 10 is corrected is depicted, divided into five frames 25a to 25e. For example, the frames 25a to 25e are displayed in the stated order along the time axis. At this time, for example, it is assumed that the display state in which the target object 10 should be corrected (the display state that causes the change blindness) is detected in a phase in which the frame 25b is displayed. In this case, the target object 10 displayed in the frames 25a and 25b is completely switched to the intermediate object 11 in the frame 25c.

In this manner, in the present embodiment, the display control unit 43 controls the display 30 to discontinuously change the target object 10 into the intermediate object 11. That is, the correction of the target object 10 is instantly performed. Further, as described above, this correction is performed in a situation where the change blindness occurs. Therefore, it is possible to correct the target object 10 without substantially preventing the user 1 from noticing the fact that the target object 10 is changed.

Referring back to FIG. 4, when the handwritten object 20 is corrected, whether or not the correction process for the handwritten object 20 is complete is determined (Step 105).

For example, in a case where a plurality of handwritten objects 20 is displayed, whether or not the morphing process for all the handwritten objects 20 is complete is determined. That is, whether or not the rate of the morphing process for each handwritten object 20 has reached a predetermined upper limit value is determined.

For example, in a case where it is determined that the correction is complete for all the handwritten objects 20 (Yes in Step 105), the correction process ends.

Moreover, for example, in a case where there is a handwritten object(s) 20 for which the correction is not complete and it is determined that the correction is not complete for all the handwritten objects 20 (No in Step 105), the processing in Step 101 and the steps after Step 101 is performed again.

Hereinafter, a timing for correcting the target object 10 will be described specifically.

As the timing for performing the correction, there can be exemplified a case of using an input operation by the user 1 (interaction with the target object 10) as a trigger and a case of using a change in visual environment that occurs regardless of the user's action as a trigger.

Here, the correction timing using the respective triggers will be described mainly showing a case of correcting a character that the user 1 has input by handwriting (handwritten object 20 representing the character) as an example.

[Correction Using User's Input Operation as Trigger]

In general, when following a moving object with the line of sight, the human line of sight moves. While the line of sight moves in this manner, it tends to be difficult to perceive visual changes that instantly occur (saccadic suppression). Also, while the object is being magnified or rotating, it tends to be difficult to perceive visual changes that instantly occur.

In the present embodiment, the target object 10 is corrected using such human perceptual characteristics. For example, when the user 1 operates the target object 10, a process of estimating an amount of movement of the user's line of sight or the like and applying correction in a case where this amount is equal to or larger than a certain amount is performed. The amount of movement of the line of sight may be detected directly from the line of sight of the user 1 or may be estimated on the basis of a change in display parameter of the target object 10 or the like.

In the present embodiment, as the display state of the target object 10, the display control unit 43 detects a state in which a display parameter including at least one of a position, a size, or an attitude of the target object 10 is changed in accordance with an input operation by the user 1. That is, the input operation by the user 1 detects a state in which the target object 10 is moved, state in which the target object 10 is magnified/reduced, or a state in which the target object 10 is rotated, for example.

Then, the display 30 is controlled to change the target object 10 into the intermediate object 11 on the basis of the detection result. For example, in a case where the change in display parameter of the target object 10 satisfies predetermined conditions, the target object 10 is switched to the intermediate object 11 considering that it is difficult to perceive visual changes that instantly occur. Accordingly, it becomes possible to correct the target object 10 without being noticed by the user.

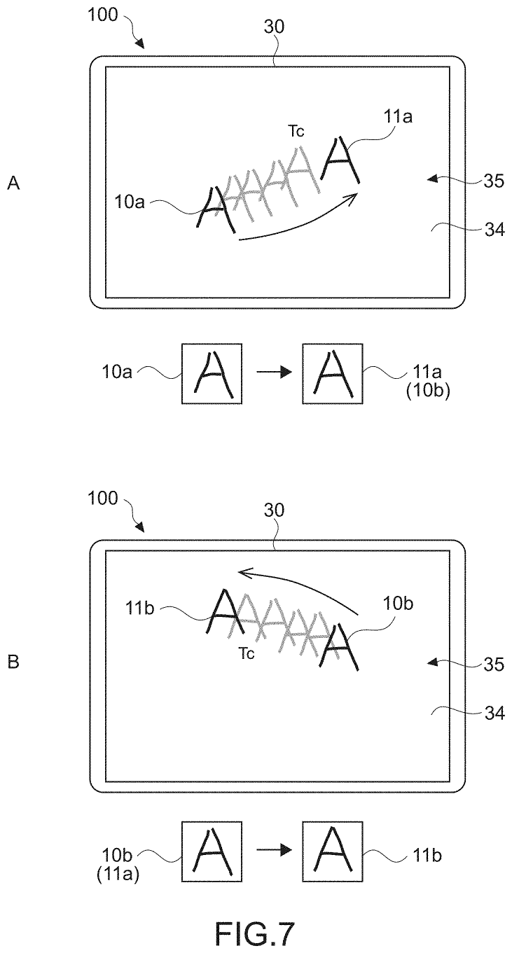

FIG. 7 is a schematic view showing an example of character correction associated with a movement operation.

Here, a movement operation (drag operation or scroll operation) by the user 1 with respect to the target object 10 is performed as the input operation by the user 1.

In FIG. 7A, a target object 10a is corrected to be an intermediate object 11a in the middle of the movement operation. Moreover, in FIG. 7 B, an intermediate object 11a corrected in FIG. 7A is corrected to be an intermediate object 11b in the middle of the movement operation as a new target object 10b. It should be noted that in FIG. 7A and FIG. 7 B, objects (frames) displayed during the movement operation are schematically depicted with the gray lines. Further, the target object 10 and the intermediate object 11 displayed on the display 30 before and after the movement operation (before and after the correction) are respectively depicted on the lower side of each diagram.

As shown in FIG. 7A, the target object 10a representing the character “A” is moved in accordance with the movement operation of the user 1. While this movement operation is performed, a change in position of the target object 10a is detected. Then, in a case where it is determined that the change in position satisfies the predetermined conditions, the target object 10a is switched to the intermediate object 11b.

Hereinafter, the timing for switching the target object 10 to the intermediate object 11 will be referred to as a correction timing Tc. It should be noted that the correction timing Tc does not need to coincide with the timing at which the change in position (change in display parameter) satisfies the predetermined conditions.

For example, considering that the change in position does not satisfy the predetermined conditions at a timing immediately after the movement operation is started, the target object 10a is displayed. Thereafter, in a case where it is determined that the change in position satisfies the predetermined conditions, the intermediate object 11a is displayed in place of the target object 10a. In the example shown in FIG. 7A, a timing in one previous frame before the movement operation ends is the correction timing Tc.

Moreover, the intermediate object 11a shown in FIG. 7A is the correction target at a time at which it is displayed on the display 30. In FIG. 7 B, the intermediate object 11a that has newly become the target object 10b is moved, and is corrected to be the intermediate object 11b in the middle of the movement. In the example shown in FIG. 7 B, a timing in one previous frame before the movement operation ends is the correction timing Tc.

It should be noted that the intermediate object 11b is an object having a higher degree of correction (rate of morphing process) than that of the intermediate object 11a. In this manner, the object that is the correction target gradually increases in degree of correction every time it is moved. Accordingly, it is possible to realize a natural correction process with a desired amount of correction without being noticed by the user 1.

The predetermined conditions for determining the change in position of the target object 10 include conditions related to an amount of change, a change time, a change speed, and the like of the position.

For example, as a process of determining the change in position of the target object 10, whether or not the amount of change (movement distance) of the position of the target object 10 exceeds a threshold is determined. Moreover, for example, whether or not the time (movement time) for which the position of the target object 10 is changed exceeds a threshold may be determined. Moreover, for example, whether or not the change speed (movement speed) of the position of the target object 10 exceeds a threshold may be determined.

Further, the predetermined conditions may be set by combining the movement distance, movement time, and movement speed as appropriate.

In this manner, in the present embodiment, the display 30 is controlled to change the target object 10 into the intermediate object 11 in accordance with a timing at which the change in position of the target object 10 (change in display parameter) satisfies the predetermined conditions.

Accordingly, a change due to switching from the target object 10 to the intermediate object 11 at the correction timing Tc can be made less outstanding. Thus, it can also be said that in the example shown in FIG. 7, the change blindness occurs to the user 1 before and after the movement operation. Accordingly, it becomes possible to correct the target object 10 without being noticed by the user 1.

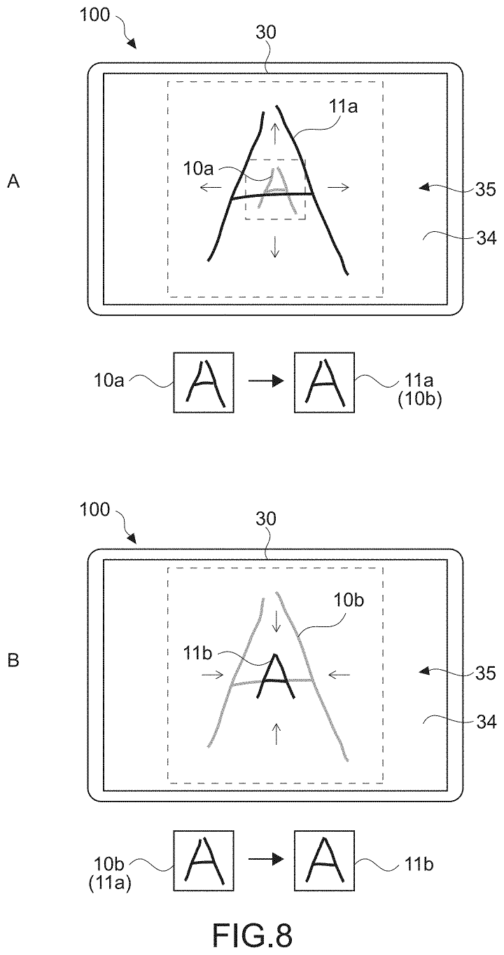

FIG. 8 is a schematic view showing an example of the character correction associated with a magnification operation.

Here, as the input operation by the user 1, the size change operation (zoom-in operation/zoom-out operation) by the user 1 with respect to the target object 10 is performed.

In FIG. 8A, the target object 10a is corrected to be the intermediate object 11a in the middle of the magnification operation. Moreover, in FIG. 8 B, the intermediate object 11a corrected in FIG. 8 A is corrected to be the intermediate object 11b as the new target object 10b in the middle of the reduction operation. Further, the target object 10 and the intermediate object 11 displayed on the display 30 before and after (before and after the correction) of each size change operation are respectively depicted on the lower side of each diagram.

As shown in FIG. 8A, the target object 10a representing the character “A” is magnified in accordance with the magnification operation of the user 1. While this magnification operation is performed, a change in size of the target object 10a is detected.

Then, in a case where it is determined that the change in size satisfies the predetermined conditions, the target object 10a is switched to the intermediate object 11b.

Also, in FIG. 8 B, the intermediate object 11a that has newly become the target object 10b is reduced and is corrected to be the intermediate object 11b in the middle.

The predetermined conditions for determining the change in size of the target object 10 include conditions related to an amount of change, a change time, a change speed, and the like of the size.

For example, as a process of determining the change in size of the target object 10, whether or not the amount of change (magnification rate/reduction rate) of the size of the target object 10 exceeds a threshold is determined. Moreover, for example, whether or not the time (size change time) for which the size of the target object 10 is changed exceeds a threshold may be determined. Moreover, for example, whether or not the change speed (size change speed) of the size of the target object 10 exceeds a threshold may be determined.

Further, the predetermined conditions may be set by combining them as appropriate.

In this manner, in the present embodiment, in accordance with a timing at which the change in size of the target object 10 (change in display parameter) satisfies the predetermined conditions, the display 30 is controlled to change the target object 10 into the intermediate object 11. It is thus conceivable that the change blindness occurs to the user 1 also in a case where the size is changed. Therefore, by setting the predetermined conditions as appropriate, it becomes possible to correct the target object 10 without being noticed by the user 1 in the middle of the magnification operation or the reduction operation.

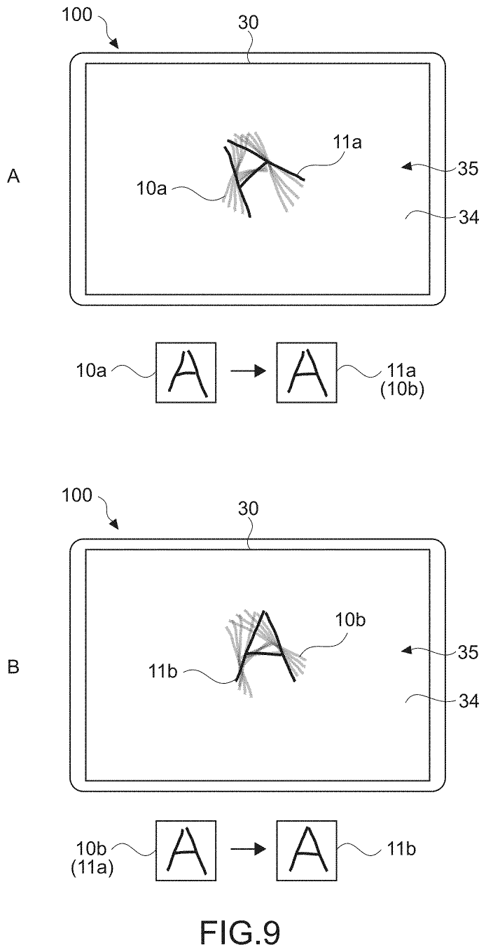

FIG. 9 is a schematic view showing an example of the character correction associated with a rotation operation.

Here, as the input operation by the user 1, a rotation operation by the user 1 with respect to the target object 10 is performed.

In FIG. 9A, the target object 10a is corrected to be the intermediate object 11a in the middle of the rotation operation of rotating in a counter-clockwise direction. Moreover, in FIG. 9 B, the intermediate object 11a corrected in FIG. 9A is corrected to be the intermediate object 11b in the middle of the rotation operation of rotating in a clockwise direction as the new target object 10b. Further, the target object 10 and the intermediate object 11 displayed on the display 30 before and after (before and after the correction) of each rotation operation are respectively depicted on the lower side of each diagram.

As shown in FIG. 9A, the target object 10a representing the character “A” is rotated in accordance with the rotation operation of the user 1. While this rotation operation is performed, a change in attitude of the target object 10a is detected. Then, in a case where it is determined that the change in attitude satisfies the predetermined conditions, the target object 10a is switched to the intermediate object 11b.

Also, in FIG. 8 B, the intermediate object 11a that has newly become the target object 10b is rotated and is corrected to be the intermediate object 11b in the middle.

The predetermined conditions for determining the change in attitude of the target object 10 include conditions related to an amount of change, a change time, a change speed, and the like of the attitude. For example, as a process of determining the change in attitude of the target object 10, whether or not the amount of change (rotation amount) of the attitude of the target object 10 exceeds a threshold is determined. Moreover, for example, whether or not the time (rotation time) for which the attitude of the target object 10 is changed exceeds a threshold may be determined. Moreover, for example, whether or not the change speed (rotation speed) of the attitude of the target object 10 exceeds a threshold may be determined.

Further, the predetermined conditions may be set by combining them as appropriate.

In this manner, in the present embodiment, in accordance with a timing at which the change in attitude of the target object 10 (change in display parameter) satisfies the predetermined conditions, the display 30 is controlled to change the target object 10 into the intermediate object 11. It is thus conceivable that the change blindness occurs to the user 1 also in a case where the attitude is changed. Therefore, by setting the predetermined conditions as appropriate, it becomes possible to correct the target object 10 without being noticed by the user 1 in the middle of the rotation operation.

[Correction Using Change in Visual Environment as Trigger]

As described above with reference to FIG. 3, in a case where a discontinuous visual stimulus is added in the visual environment of the user 1, the visual change blindness occurs, and it is difficult to perceive a change before and after the visual stimulus is added.

In the present embodiment, the correction using the change blindness is performed by detecting a pattern that generates such a discontinuous visual stimulus on the display 30 in the actual visual environment.

In the present embodiment, the display control unit 43 detects the state in which the display of the target object 10 is hindered as the display state of the target object 10, and the display is controlled to change the target object 10 into the intermediate object 11 on the basis of the detection result.

Here, the state in which the display of the target object 10 is hindered includes a state in which the target object 10 is invisible (state in which the target object 10 is occluded) or the state in which it is difficult to watch the target object 10.

For example, there can be a case where the target object 10 is occluded because another window or the like is displayed with an expression of a graphical user interface (GUI) on the terminal apparatus 100 (GUI expression on the screen image 35) or a case where it is difficult to watch the target object 10 with such an expression (afocus) to blur the entire screen. Further, it is also conceivable that light reflection or the like of the display surface 34 itself makes the target object 10 invisible.

In the present embodiment, the correction of the target object 10 is performed using such a state in which the display of the target object 10 is hindered.

Specifically, the display control unit 43 detects a hindered region in which the display of the target object 10 is hindered. Then, the display 30 is controlled to change the target object 10 included in the hindered region into the intermediate object.

Therefore, only in a case where the display of the target object 10 is hindered, the hindered target object 10 is selectively corrected. It should be noted that as to the target object 10 the display of which is not hindered, the target object 10 is not corrected. Accordingly, it becomes possible to correct only a portion that it is difficult for the user 1 to notice, and it becomes possible to secretly realize correction with no discomfort.

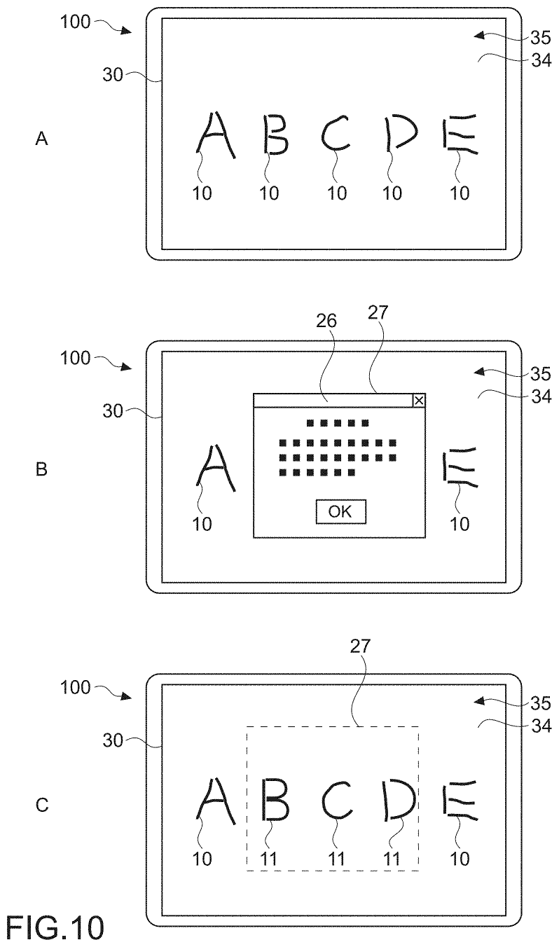

FIG. 10 is a schematic view showing an example of the correction associated with the occlusion of the target object 10 in the screen image 35. Here, it is assumed that a pop-up window 26 is displayed on the screen image 35 including the target object 10 as an example of the GUI expression.

In FIG. 10A to FIG. 10 C, screen images 35 (terminal apparatus 100) before display of the pop-up window 26, during the display, and after the display are schematically depicted.

In FIG. 10A, five target objects 10 corresponding to five handwritten characters “A” to “E” are displayed, arranged in a horizontal column. In this state, the pop-up window 26 is displayed at the center of the screen as shown in FIG. 10 B. At this time, the target object 10 corresponding to “B”, “C”, and “D” in FIG. 10 B are hidden by the pop-up window 26 and invisible. It should be noted that the target objects 10 corresponding to “A” and “E” are displayed on the display 30 also during display of the pop-up window 26.

Here, the display control unit 43 detects a state in which the target objects 10 are occluded on the screen image 35. For example, the display control unit 43 detects a hindered region 27 hindered by the pop-up window 26. Here, the entire region of the pop-up window 26 is detected as the hindered region 27. Then, target objects 10 included in the hindered region 27 (here, target objects 10 corresponding to “B”, “C”, and “D”) are determined.

In this manner, the presence/absence and the like of an occluded target object 10 are detected. In a case where an occluded target object 10 is present, the object is corrected.

Specifically, a process of changing the target objects 10 included in the hindered region 27 into the corresponding intermediate objects 11, respectively, is performed. As a result, as shown in FIG. 10 C, the intermediate objects 11 corresponding to “B”, “C”, and “D” are displayed in the portion in which the target objects 10 corresponding to “B”, “C”, and “D” had been displayed after the pop-up window 26 disappears.

It should be noted that the target objects 10 corresponding to “A” and “E” are displayed on the display 30 with no change also after the pop-up window 26 disappears.

Thus, the target objects 10 that had been hidden by the pop-up window 26 are selectively corrected. It should be noted that since the change blindness associated with the occlusion of the display by the pop-up window 26 occurs, changes due to switching from the target objects 10 to the intermediate objects 11 do not outstand.

Further, a state in which the target objects 10 are blurred on the screen image 35 may be detected as the state in which the target objects 10 are occluded on the screen image 35. For example, in a case where the entire screen is blurred with a predetermined blur filter, the entire screen is detected as an occlusion region. Then, while the blur filter is applied, all the target objects 10 included in the screen image 35 are corrected.

Therefore, after the blur filter is cancelled, the corresponding intermediate objects 11 are displayed in place of the respective target objects 10. Also in such a case, it is possible to correct the target object 10 without being noticed by the user 1.

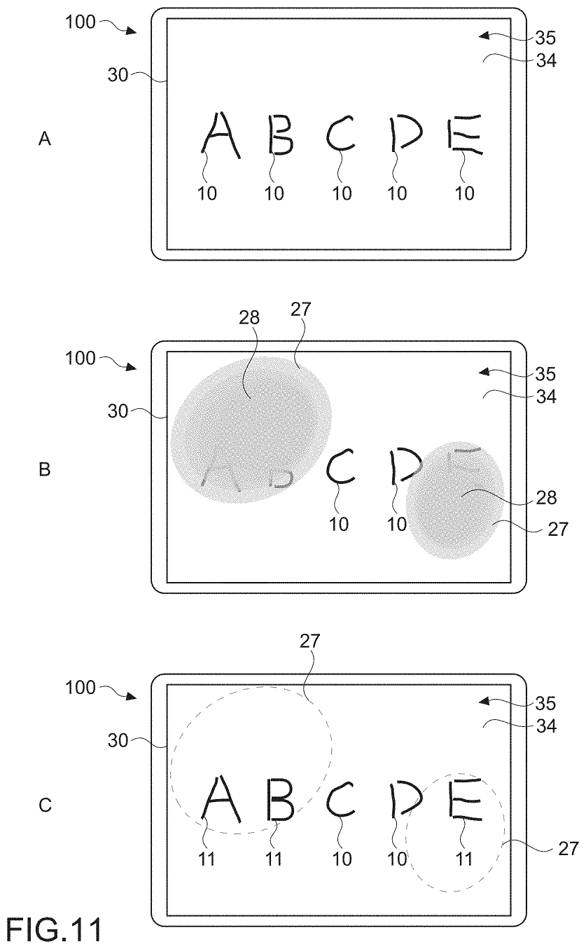

FIG. 11 is a schematic view showing an example of the correction associated with the occlusion of the target object 10 on the display surface 34 of the display 30. Here, a case where due to external light 28 (e.g., sunlight filtering through leaves or the like) emitted from the surrounding environment of the user 1, brightness of the display surface 34 changes, which makes target objects 10 and the like displayed on the display 30 invisible will be assumed.

In In FIG. 11A to FIG. 11 C, screen images 35 (terminal apparatus 100) before emission in which the external light 28 is emitted, during the emission, and after the emission are schematically depicted. It should be noted that since the external light 28 constantly changes in the actual visual environment, the external light 28 as shown in FIG. 11 B for example is continuingly emitted having the brightness and the region changed.

In FIG. 11A, the five target objects 10 corresponding to “A” to “E” are displayed, arranged in a horizontal column. It is assumed that in this state, as shown in FIG. 11 B, the display surface 34 is irradiated with the external light 28. At this time, in FIG. 11 B, the target objects 10 corresponding to “A”, “B”, and “E” become substantially invisible due to reflection or the like of the external light 28. It should be noted that the target objects 10 corresponding to “C” and “D” are not irradiated with the external light 28.

Here, the display control unit 43 detects a state in which the display of the target objects 10 is hindered on the display surface 34. For example, due to the irradiation with the external light 28, time and region in which the graphics of the targets are invisible spontaneously are detected. That is, hindered regions 27 corresponding to the timing at which the target objects 10 are invisible due to the external light 28 or it is difficult to watch the target objects 10 is detected. The hindered regions 27 are detected, for example, as regions in which the brightness exceeds a predetermined threshold on the display surface 34. For such detection of the state of the display surface 34, an image of the display surface 34 captured by an external camera or the like is used. Alternatively, regions irradiated with the external light 28 and the like may be detected using an optical sensor and the like provided in the display surface 34.

In the example shown in FIG. 11, the hindered regions 27 are detected on the left-hand side and the right-hand side of the display surface 34 at the same timing. Target objects 10 included in the hindered regions 27 (here, target objects 10 corresponding to “A”, B″, and “E”) are determined.

In this manner, the presence/absence and the like of a target object 10 the display of which is hindered by the external light 28 are detected. Then, in a case where a target object 10 the display of which is hindered is present, the object is corrected.

For example, as in FIG. 10, a process of changing the target objects 10 included in the hindered regions 27 into the corresponding intermediate objects 11, respectively, is performed. As a result, as shown in FIG. 11 C, the intermediate objects 11 corresponding to “A”, “B”, and “E” are displayed in the portions in which the target objects 10 corresponding to “A”, “B”, and “E” had been displayed after the irradiation with the external light 28 ends.

It should be noted that the target objects 10 corresponding to “C” and “D” are displayed with no change also after the external light 28 disappears.

Thus, the target objects 10 that had been invisible due to the external light 28 are selectively corrected. It should be noted that since the change blindness associated with the occlusion of the display by the external light 28 occurs, changes due to switching from the target objects 10 to the intermediate objects 11 do not outstand.

[Correction of Handwritten Illustration]

Hereinabove, the process of correcting the handwritten objects 20 representing the handwritten characters as the target objects 10 has been mainly described. The present technology is not limited thereto, and the present technology can also be applied to a handwritten object 20 representing a handwritten icon (handwritten illustration).

FIG. 12 is a schematic view showing an example of the morphing process as to the handwritten illustration.

FIG. 12A shows a handwritten object 20 for which the rate of the morphing process is set to be 0 and which is an object representing a handwritten icon by the user 1 with no change. Here, a cylindrical illustration curved to have a concave side surface is drawn.

Moreover, FIG. 12 C shows an estimated object 22 (reference object) which is estimated from the handwritten object 20 of FIG. 12A and which is an object for which the rate of the morphing process is 1. Here, shapes of portions that are upper and lower surfaces of the cylindrical illustration are estimated to be elliptical shapes. Further, curve lines representing the side surface are estimated to be line-symmetrical curve lines connecting to the respective ellipses.

FIG. 12 B shows an intermediate object 11 between the handwritten object 20 and the estimated objects 22. The intermediate object 11 is an object with the respective parts of the illustration (here, the curve lines that are the upper surface, the lower surface, and the side surface) corrected using the estimated object 22 as the criteria in accordance with a set rate of the morphing process.

Also in a case where the handwritten object 20 representing the handwritten icon is corrected, the intermediate object 11 is generated to become closer to the estimated objects 22 every time it is corrected.

FIG. 13 is a schematic view showing an example of the correction as to the handwritten illustration. In FIG. 13A, the user 1 performs a movement operation with respect to the target object 10 (e.g., the handwritten object 20 shown in FIG. 12A). In this process, the target object 10 is switched to the corresponding intermediate objects 11 (e.g., the intermediate object 11 shown in FIG. 12 B).

Specifically, while the movement operation is performed, a change in position of the target object 10 is detected, and in a case where it is determined that the change in position satisfies the predetermined conditions, the target object 10 is switched to the intermediate object 11 (see FIG. 7). In the example shown in FIG. 13, a timing in one previous frame before the movement operation ends is the correction timing Tc at which the target object 10 switches to the intermediate object 11.

In addition, it is also possible to correct the target object 10 representing the handwritten illustration when the size change operation or the rotation operation described above with reference to FIG. 8 or 9 is performed. Moreover, it is also possible to perform the correction by using a state in which in which the display of the target object 10 representing the handwritten illustration is hindered by another object, external light, or the like as described above with reference to FIG. 10 or 11. In any case, the use of characteristics of the change blindness can realize correction without being noticed by the user 1.

Hereinabove, in the controller 40 according to the present embodiment, the target object 10 that is the correction target is output through the display 30. Then, in accordance with the display state of the output target object 10, the display 30 is controlled so that the target object 10 changes into the intermediate object 11 between the target object 10 and the reference object 13 corresponding to the target object 10. By changing the target object 10 in accordance with the display state of the target object 10 in this manner, it becomes possible to correct the display without being noticed by the user 1.

For example, in a method of automatically and instantly correcting the contents input by the user, the user recognizes that the contents input by the user is corrected because the moment of correction is obvious. Therefore, the user may feel the corrected display object is not what the user has input.

As a method for avoiding such a situation, for example, it is conceivable to correct the object in a moment when the user does not watch the object. In this case, although the user is prevented from perceiving the moment when the object is corrected, the object is not corrected in a state in which the user is carefully watching the object, so there is a possibility that the object cannot be sufficiently corrected.

In the present embodiment, in a case where the terminal apparatus 100 automatically performs correction, the correction of the target object 10 is performed using the timing of the visual change blindness at which the user 1 does not notice it. For example, when the user 1 moves the target object 10 or when it is difficult to watch the target object 10, the target object 10 is corrected.

Accordingly, the correction of the target object 10 becomes less outstanding, and it becomes possible to correct the target object 10 without notice. As a result, the user 1 can perform input, still having a sense of agency, i.e., the feeling of control over the input action of the user 1 even after the input contents are corrected.

Moreover, even when the user 1 is carefully watching the target object 10, the correction is performed at a timing at which a movement operation or magnification operation is performed on the target object 10. Accordingly, for example, even during edition of the target object 10, it is possible to sufficiently correct the target object 10 without being noticed by the user 1. As a result, it becomes possible to support input operations by the user 1 and the like without deteriorating the sense of agency of the user 1.

### OTHER EMBODIMENTS

The present technology is not limited to the above-mentioned embodiments, and various other embodiments can be made.

The terminal apparatus provided with the touch panel has been mainly described above. The present technology is not limited thereto, and the present technology can be applied to any display apparatus. For example, a laptop PC provided with a trackpad and the like, a stationary PC, and the like may be used. In any case, the object is corrected in accordance with the display state of the target object that is the correction target on the display that displays contents of the processing.

The method of correcting the stroke(s) of the handwritten object on an object-by-object basis (on a character-by-character basis or on an icon-by-icon basis) has been mainly described above. The present technology is not limited thereto, and for example, each of strokes constituting one handwritten object may be individually corrected. For example, in a case where a state in which it is difficult to watch some of strokes included in the handwritten object is detected, a process of correcting only those strokes can be performed.

Moreover, in the above-mentioned handwriting input example, the stroke data has been described. In the handwriting input, a variety of expressions can be made in accordance with a writing pressure, a touch, the input speed, and the like when input is performed, for example.

Further, not only black and white input but also expressions of colors and the like can be made. For example, input data including such data may be generated and a target object 10 reproducing the writing pressure, touch, colors, and the like may be corrected. For example, in a case where the user 1 creates a handwritten sketch, watercolor painting, or the like, the present technology may be applied.

In this case, for example, a departing portion exceeding a threshold, a portion in which color gradients are rapidly changed, a portion in which line thickness is rapidly changed, or the like is gradually corrected without notice. In this case, input habit and the like of the user 1 may be recognized and a direction of correction may be automatically recognized. Accordingly, the user 1 can finely finish the creation that the user 1 wants to make while keeping a strong sense of agency.

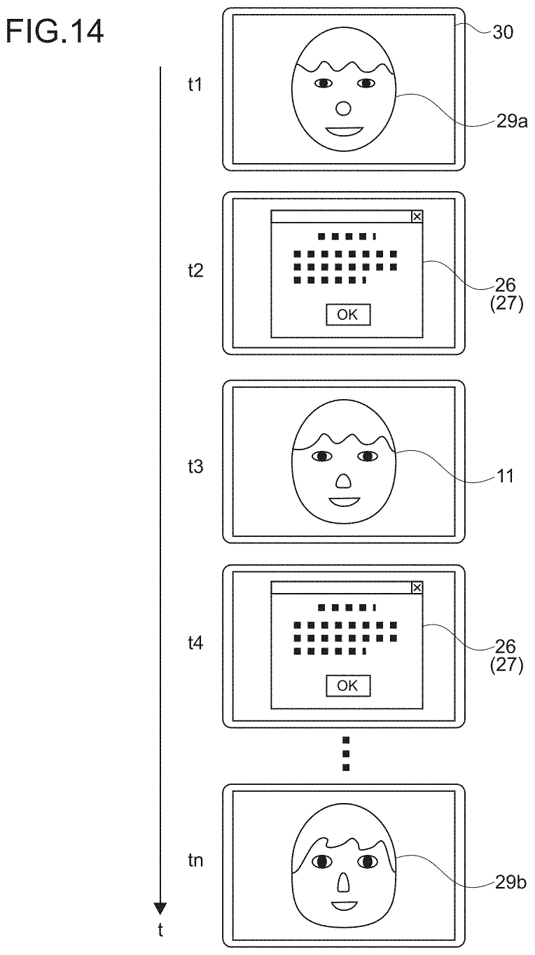

FIG. 14 is a schematic view showing an example of the correction of the image object.

The case of correcting the handwritten object 20 representing the input result of the handwriting input by the user 1 has been mainly described. The present technology is not limited thereto, and for example, the present technology may be applied for correcting an image object 29 displayed on the display 30.

In FIG. 14, an image object 29a displayed at a time t1 is corrected to be an image object 29b by a time tn. In this example, the target object 10 is the image object 29a and the reference object 13 is the other image object 29b different from the image object 29a.

It should be noted that an object displayed at a time t3 is an intermediate object 11 between the image object 29a and the image object 29b.

In a case of correcting pixel data (image object 29) such as a photograph and a painting, a morphing process from pixel data (image object 29a) that is a correction target to pixel data (image object 29b) that is a final correction result is performed.

As the morphing process for the pixel data, for example, not a process such as alpha blending in which two images are simply overlapped and displayed, but a process in which the intermediate object 11 that can be established alone as an image is performed.

For example, the image (intermediate object 11) shown at the time t3 is an image that can be recognized alone as a face and is not an image in which two faces are overlapped and displayed, for example.

In this manner, the intermediate object 11 is generated so that a development process of a change from the target object 10 to the intermediate object 11 is not identifiable.

For example, the image object 29a and the image object 29b are converted into vector data in the same feature amount space. An image object representing a point on a path (trajectory) connecting two points represented by respective vectors is generated as the intermediate object 11. Alternatively, the intermediate object 11 may be generated by a morphing process using machine learning or the like. Accordingly, it becomes possible to display the intermediate object 11 that can be established alone as an image.

As shown in FIG. 14, for example, after the image object 29a is displayed at the time t1, the pop-up window 26 is displayed at a time t2. At this time, the image object 29a is occluded by the pop-up window 26 and is temporarily invisible. Using the timing at which the image object 29a (target object 10) is occluded in this manner, the image object 29a is switched to the intermediate object 11.

Therefore, when the pop-up window 26 disappears at the time t3, the intermediate object 11 is displayed in place of the image object 29a. Thereafter, between t4 to tn, the intermediate object 11 is gradually switched and displayed to become closer to the image object 29b without being noticed.

Accordingly, it becomes possible to correct the image object 29 gradually without being noticed by the user 1. Accordingly, for example, it becomes possible to decorate the user and the like without being noticed by a communication partner.

The case where the information processing method according to the present technology is performed by the computer such as the terminal apparatus operated by the user has been described. However, the information processing method and the program according to the present technology may be performed by a computer installed in the terminal apparatus and another computer capable of communicating with the computer via a network or the like.

That is, the information processing method and the program according to the present technology may be performed not only in a computer system configured by a single computer but also in a computer system in which a plurality of computers cooperatively operate. It should be noted that in the present disclosure, the system means a set of a plurality of components (apparatus, module (parts), and the like) and it does not matter whether or not all the components are housed in the same casing. Therefore, both of a plurality of apparatuses housed in separate casings and connected to one another via a network and a single apparatus having a plurality of modules housed in a single casing are the system.

Performing the information processing method and the program according to the present technology by the computer system includes, for example, both of a case where a single computer performs the process of controlling the display apparatus to change the target object into the intermediate object and the like and a case where different computers perform the respective processes. Moreover, performing the respective processes by a predetermined computer includes causing another computer to perform some or all of those processes and acquiring the results.

That is, the information processing method and the program according to the present technology can also be applied to a cloud computing configuration in which a plurality of apparatuses shares and cooperatively processes a single function via a network.

At least two features of the features according to the present technology, which have been described above, may be combined. That is, the various features described in the respective embodiments may be arbitrarily combined across the respective embodiments. Moreover, the above-mentioned various effects are merely exemplary and not limitative, and other effects may be provided.

In the present disclosure, the “same”, “equal”, “orthogonal”, and the like are concepts including “substantially the same”, “substantially equal”, “substantially orthogonal”, and the like. For example, states included in a predetermined range (e.g., ±10% range) using “completely the same”, “completely equal”, “completely orthogonal”, and the like as the bases are also included.

It should be noted that the present technology can also take the following configurations.

(1) An information processing apparatus, including

a display control unit that controls a display apparatus to display a target object that is a correction target and controls the display apparatus to change, in accordance with a display state of the target object after the target object is displayed, the target object into an intermediate object between the target object and a reference object corresponding to the target object.

(2) The information processing apparatus according to (1), in which

the display control unit detects the display state that causes visual change blindness to a user who watches the target object and controls the display apparatus to change, in accordance with a timing at which the display state that causes the visual change blindness is detected, the target object into the intermediate object.

(3) The information processing apparatus according to (2), in which

the display control unit controls the display apparatus so that the intermediate object becomes closer to the reference object every time the display state that causes the visual change blindness is detected.

(4) The information processing apparatus according to any one of (1) to (3), in which

the display control unit detects, as the display state, a state in which a display parameter including at least one of a position, a size, or an attitude of the target object is changed in accordance with an input operation by a user, and controls the display apparatus to change the target object into the intermediate object on the basis of the detection result.

(5) The information processing apparatus according to (4), in which

the input operation by the user includes at least one of a movement operation, a size change operation, or a rotation operation by the user with respect to the target object.

(6) The information processing apparatus according to (4) or (5), in which

the display control unit controls the display apparatus to change the target object into the intermediate object in accordance with a timing at which at least one of an amount of change of the display parameter, a time for which the display parameter is changed, or a change speed of the display parameter exceeds a predetermined threshold.

(7) The information processing apparatus according to any one of (1) to (6), in which

the display control unit detects, as the display state, a state in which display of the target object is hindered, and controls the display apparatus to change the target object into the intermediate object on the basis of the detection result.

(8) The information processing apparatus according to (7), in which

the display control unit generates a screen image that is output of the display apparatus, and detects a state in which the target object is occluded in the screen image or a state in which the target object is blurred in the screen image.

(9) The information processing apparatus according to (7) or (8), in which

the display apparatus has a display surface, and

the display control unit detects a state in which display of the target object is hindered on the display surface.

(10) The information processing apparatus according to any one of (7) to (9), in which

the display control unit detects a hindered region in which the display of the target object is hindered, and controls the display apparatus to change the target object included in the hindered region into the intermediate object.

(11) The information processing apparatus according to any one of (1) to (10), in which

the display control unit controls the display apparatus to discontinuously change the target object into the intermediate object.

(12) The information processing apparatus according to any one of (1) to (11), in which

the display control unit generates the intermediate object so that a development process of the change from the target object to the intermediate object is not identifiable.

(13) The information processing apparatus according to any one of (1) to (12), in which

the display control unit generates the intermediate object by performing a morphing process of making the target object closer to the reference object.

(14) The information processing apparatus according to any one of (1) to (13), in which

the target object is a handwritten object representing an input result of handwriting input by the user, and

the reference object is an estimated object obtained by estimating input contents of the handwriting input.

(15) The information processing apparatus according to (14), in which

the display control unit generates the intermediate object by performing a morphing process of making the handwritten object closer to the estimated object, and sets a rate of the morphing process that is applied to the handwritten object to be smaller than a rate of the morphing process in a case where a result of the morphing process coincides with the estimated object.

(16) The information processing apparatus according to (14) or (15), in which

the handwritten object is at least one of an object representing a handwritten character by the user or an object representing a handwritten icon by the user.

(17) The information processing apparatus according to any one of (1) to (16), in which

the target object is a first image object, and

the reference object is a second image object different from the first image object.

(18) An information processing method, including

by a computer system,

controlling a display apparatus to display a target object that is a correction target and controlling the display apparatus to change, in accordance with a display state of the target object after the target object is displayed, the target object into an intermediate object between the target object and a reference object corresponding to the target object.

(19) A computer-readable recording medium on which a program is recorded, the program executing

a step of controlling a display apparatus to display a target object that is a correction target and controlling the display apparatus to change, in accordance with a display state of the target object after the target object is displayed, the target object into an intermediate object between the target object and a reference object corresponding to the target object.

### REFERENCE SIGNS LIST

1 user
10, 10a, 10b target object
11, 11a, 11b intermediate object
13 reference object
20 handwritten object
22 estimated object
27 the hindered region
29a, 29b image object
30 display
33 storage unit
34 display surface
35 screen image
40 controller
41 input detection unit
42 reference object acquisition unit
43 display control unit
100 terminal apparatus

1. An information processing apparatus, comprising
a display control unit that controls a display apparatus to display a target object that is a correction target and controls the display apparatus to change, in accordance with a display state of the target object after the target object is displayed, the target object into an intermediate object between the target object and a reference object corresponding to the target object.

2. The information processing apparatus according to claim 1, wherein
the display control unit detects the display state that causes visual change blindness to a user who watches the target object and controls the display apparatus to change, in accordance with a timing at which the display state that causes the visual change blindness is detected, the target object into the intermediate object.

3. The information processing apparatus according to claim 2, wherein
the display control unit controls the display apparatus so that the intermediate object becomes closer to the reference object every time the display state that causes the visual change blindness is detected.

4. The information processing apparatus according to claim 1, wherein
the display control unit detects, as the display state, a state in which a display parameter including at least one of a position, a size, or an attitude of the target object is changed in accordance with an input operation by a user, and controls the display apparatus to change the target object into the intermediate object on a basis of the detection result.

5. The information processing apparatus according to claim 4, wherein
the input operation by the user includes at least one of a movement operation, a size change operation, or a rotation operation by the user with respect to the target object.

6. The information processing apparatus according to claim 4, wherein
the display control unit controls the display apparatus to change the target object into the intermediate object in accordance with a timing at which at least one of an amount of change of the display parameter, a time for which the display parameter is changed, or a change speed of the display parameter exceeds a predetermined threshold.

7. The information processing apparatus according to claim 1, wherein
the display control unit detects, as the display state, a state in which display of the target object is hindered, and controls the display apparatus to change the target object into the intermediate object on a basis of the detection result.

8. The information processing apparatus according to claim 7, wherein
the display control unit generates a screen image that is output of the display apparatus, and detects a state in which the target object is occluded in the screen image or a state in which the target object is blurred in the screen image.

9. The information processing apparatus according to claim 7, wherein
the display apparatus has a display surface, and
the display control unit detects a state in which display of the target object is hindered on the display surface.

10. The information processing apparatus according to claim 7, wherein
the display control unit detects a hindered region in which the display of the target object is hindered, and controls the display apparatus to change the target object included in the hindered region into the intermediate object.

11. The information processing apparatus according to claim 1, wherein
the display control unit controls the display apparatus to discontinuously change the target object into the intermediate object.

12. The information processing apparatus according to claim 1, wherein
the display control unit generates the intermediate object so that a development process of the change from the target object to the intermediate object is not identifiable.

13. The information processing apparatus according to claim 1, wherein
the display control unit generates the intermediate object by performing a morphing process of making the target object closer to the reference object.

14. The information processing apparatus according to claim 1, wherein
the target object is a handwritten object representing an input result of handwriting input by the user, and
the reference object is an estimated object obtained by estimating input contents of the handwriting input.

15. The information processing apparatus according to claim 14, wherein
the display control unit generates the intermediate object by performing a morphing process of making the handwritten object closer to the estimated object, and sets a rate of the morphing process that is applied to the handwritten object to be smaller than a rate of the morphing process in a case where a result of the morphing process coincides with the estimated object.

16. The information processing apparatus according to claim 14, wherein
the handwritten object is at least one of an object representing a handwritten character by the user or an object representing a handwritten icon by the user.

17. The information processing apparatus according to claim 1, wherein
the target object is a first image object, and
the reference object is a second image object different from the first image object.

18. An information processing method, comprising by a computer system,
controlling a display apparatus to display a target object that is a correction target and controlling the display apparatus to change, in accordance with a display state of the target object after the target object is displayed, the target object into an intermediate object between the target object and a reference object corresponding to the target object.

19. A computer-readable recording medium on which a program is recorded, the program executing
a step of controlling a display apparatus to display a target object that is a correction target and controlling the display apparatus to change, in accordance with a display state of the target object after the target object is displayed, the target object into an intermediate object between the target object and a reference object corresponding to the target object.
